(19) United States
(12) Patent Application Publication
(10) Pub. No.: US 2012/0031437 A1
(43) Pub. Date: Feb. 9, 2012

(54) MULTI-CHAMBER DEGREASING MACHINE

(76) Inventor: Roberto Beguin, Arrissoules (CH)

(21) Appl. No.: 13/262,470

(22) PCT Filed: Mar. 31, 2010
(86) PCT No.: PCT/IB10/51408

§ 371 Date: Oct. 21, 2011

(30) Foreign Application Priority Data
Mar. 31, 2009 (EP) 09157007.7

(51) Int. Cl. B08B 3/08; B08B 7/00

(52) U.S. Cl. 134/25.1; 134/80

(57) ABSTRACT

The invention relates to machine for treating parts, for example for cleaning metal parts with solvents, transported in a basket in a treatment station, said machine including a plurality of treatment stations and a cylinder including a number of chambers at least equal to the number of stations, said chambers receiving at least one basket with said parts, the cylinder including sealing means and transporting the baskets into the chambers in the consecutive treatment stations of the machine.

The present application claims the priority of earlier European patent application 09157007.7 of Mar. 31, 2009 the content of which is in its entirety incorporated by reference into the present application.

### FIELD OF THE INVENTION

The present invention relates to machines for washing parts, for example metal parts used in industry.

More specifically, the present invention relates to a machine for degreasing parts using solvent and/or hydrocarbons which can wash, degrease and dry said parts while remaining environmentally friendly.

### PRIOR ART

Such machines are known in the prior art and are marketed for example by the companies UNION SPA, TEKNOX, ROLL, FIRBIMATIC SPA, ECOBOME INDUSTRIE or DÜRR for example.

Typically, these machines use a washing chamber into which a basket carrying the parts that are to be cleaned is introduced, for example into an appropriate housing. In some instances, inside this housing there is a basket holder structure that allows washing to be carried out either statically or in rotation. The chamber is connected to a circuit that sprays solvent over the parts that are to be washed, the circuit being connected to a pump. Washing can be done by spraying and/or by immersion.

On the outlet side of the chamber there are discharge valves and filters for the used washing liquid.

The part washing cycles generally comprise the following steps:
introducing the basket into the chamber,
prewashing using a solvent by spraying;
rinsing with a solvent;
final washing
drying
deodorizing the chamber, for example by passing air over a filter, for example an active carbon filter, and
extracting the basket from the chamber.

Such cycles and the machines that perform them do not perform well in as much as it is necessary to wait for all of the steps to have been completed before the basket can be taken out of the chamber. The total time taken to treat a basket is therefore equal to the overall sum of the times needed to complete all of the chosen steps, and what is more the significant volume of the chamber means also that significant quantities of solvent have to be treated (distilled) and that significant volumes of air have to be treated (vacuum, deodorizing). The throughput of such machines is therefore not optimized and, depending on the number of steps chosen, the cycle may prove particularly lengthy.

### PRINCIPLE OF THE INVENTION

The principle underlying the present invention differs (from what is currently done by manufacturers as indicated above), through the presence of several independent working chambers (for example five chambers instead of just one), which are mounted on a rotary carousel and which each in turn pass through the various stations described below.

As a result, all the stations operate at the same time in parallel, as long as there is a basket at the corresponding station, and if not, the latter preferably switches to standby. As for the rest of the machine, all the peripherals (the distiller, the vacuum pump, solvent pump, tanks, separator, chiller, active carbon, filters, etc.) are standardized with respect to those currently used, but of smaller size and lower consumption.

This design entails the use of a cylindrical basket provided with an identification (an optical identifier, barcode, etc.) specific to each different program that might be desired (in general, three are enough).

The cycle time is thus reduced to a duration corresponding to that of the longest operation or step instead of still being the sum of the duration of all the operations or steps performed as it was in the prior art.

Such a machine therefore has a far better throughput than the known machines.

### DESCRIPTION OF THE FIGURES

The invention will be better understood through the description of one embodiment thereof and through the related figures, in which:

FIG. 1 is a schematic diagram of a machine according to the invention;

FIG. 2 is a perspective view of the machine according to the invention;

FIGS. 3 and 4 are views of the machine from above, in two different situations;

FIG. 5 is a perspective and part-sectioned view of the machine;

FIG. 6 is a perspective and part-sectioned view of the machine;

FIG. 7 is a perspective and part-sectioned view of the carousel;

FIG. 8 schematically illustrates an active seal of the carousel;

FIG. 9 is a partial view of the active seal;

FIG. 10 is a perspective view of a basket.

### DETAILED DESCRIPTION OF THE INVENTION

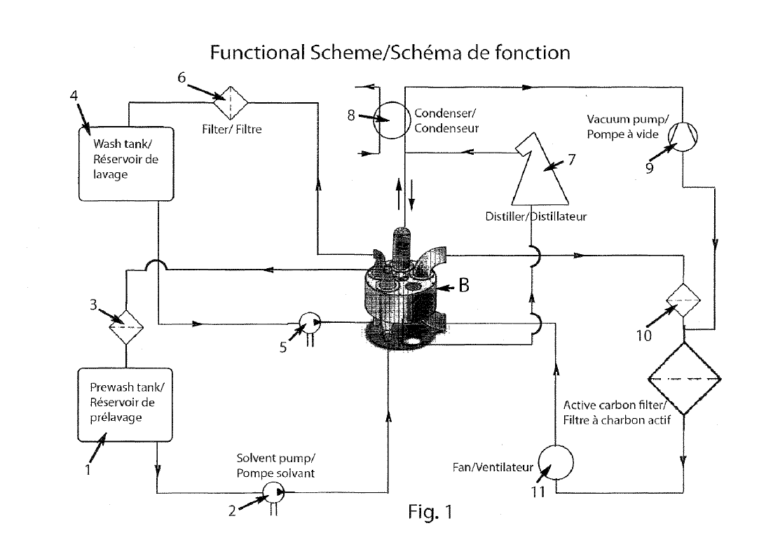

A schematic diagram illustrating the machine according to the invention is given in FIG. 1. In the middle of the figure is the carousel B according to the invention, which will be described in greater detail further on in this application.

The various steps in the treatment cycle for treating the parts in the machine are depicted by way of illustration around the carousel B, each station corresponding to one step through which the carousel rotates.

For example, starting from the empty position that allows the carousel B to be fed with and unloaded of baskets, in the clockwise direction the chamber arrives at the first step which is a prewash station. In the circuit needed for this step there is therefore at least one tank 1 containing a liquid (typically a solvent) and a pump 2 for circulating the solvent in the prewash circuit. For preference, a filter 3 is added to the circuit to filter the liquid that has been used.

Next, the next station that the chamber arrives at as the carousel rotates clockwise is the wash station. In this circuit, there is therefore at least one tank containing the washing liquid, a pump 5 for supplying the station and a filter 6.

The next station in the clockwise direction of rotation is, for example, a combined vapor phase and drying station for the washed parts. At this station, first of all solvent vapors taken directly from the distiller 7 are circulated (to rinse and raise the temperature of the parts) then an absolute vacuum is created using a vacuum pump 9 (for drying by evaporation), passing through a condenser 8.

Finally, the last station of the machine rotating in the clockwise direction, in this example, is a deodorizing phase and the circuit comprises at least one condenser 8, a vacuum pump 9, an active carbon filter 10 and a fan 11.

Once the carousel B has rotated through one step more in the clockwise direction, the chamber that has passed through all the successive stations finds itself back again in the initial basket loading/unloading position and the treated basket can be removed and a new basket for treating loaded.

Since in the system operates in a parallel mode, all the chambers of the carousel B are loaded with a basket, and so all the steps of the successive stations are performed in parallel on a different basket and the example given hereinabove relates to the successive steps applied to a basket in a given chamber.

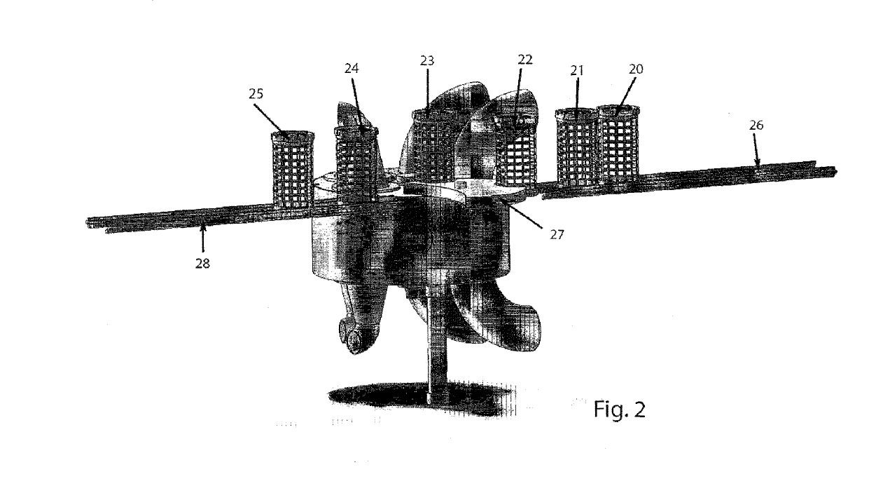

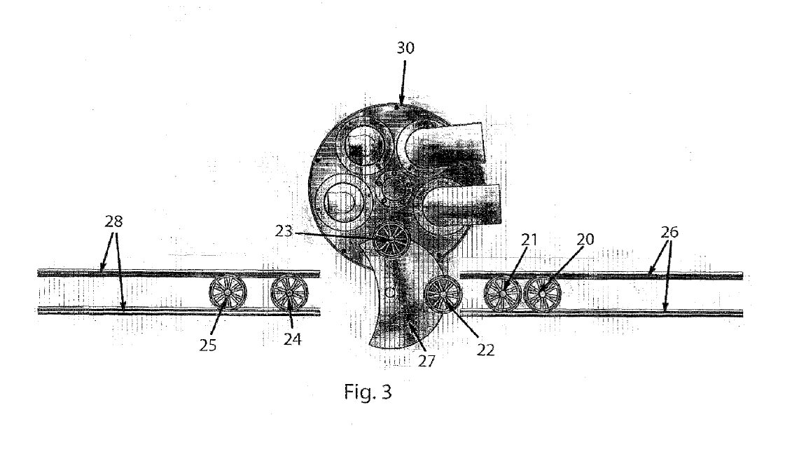

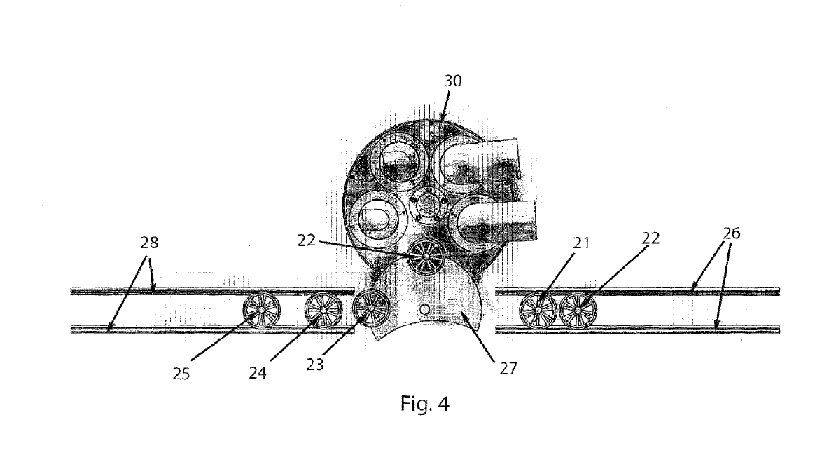

FIG. 2 is a perspective view of the step of unloading baskets from/loading baskets into a chamber and FIGS. 3 and 4 are views from above.

As these figures show, baskets 20, 21, 22 intended to be treated in the machine 30 arrive on a drip tray 26 (for example formed of rails). These baskets (which will be described in greater detail later on) contain parts that are to be treated, for example to be cleaned. The basket 22 is illustrated in a position in which it is grasped by a loading/unloading means 27, for example a rotary means, which is used to remove the basket that has been treated (the basket 23 in FIGS. 2 to 4) and bring in a new basket that is to be treated (the basket 22) over the chamber that is to accept it. The illustrated position of the loading/unloading means 27 is the position in which it has taken hold of the treated basket 23 that is leaving the machine 30 and the new basket to be treated 22 on the end of the drip tray 26. In FIG. 4, the means 27 has rotated through approximately 90° in the counterclockwise direction such that the treated basket 23 is now on an exit/discharge drip tray 28 (for example rails) and the new basket to be treated 22 is in position to be fed into the machine 30. As will have been appreciated from the foregoing, the baskets 24 and 25 are likewise baskets that have been treated and which are leaving the machine along the unloading line 28.

Of course, the loading/unloading means 27 is given by way of example and other equivalent means for loading and unloading baskets into and out of the machine are conceivable.

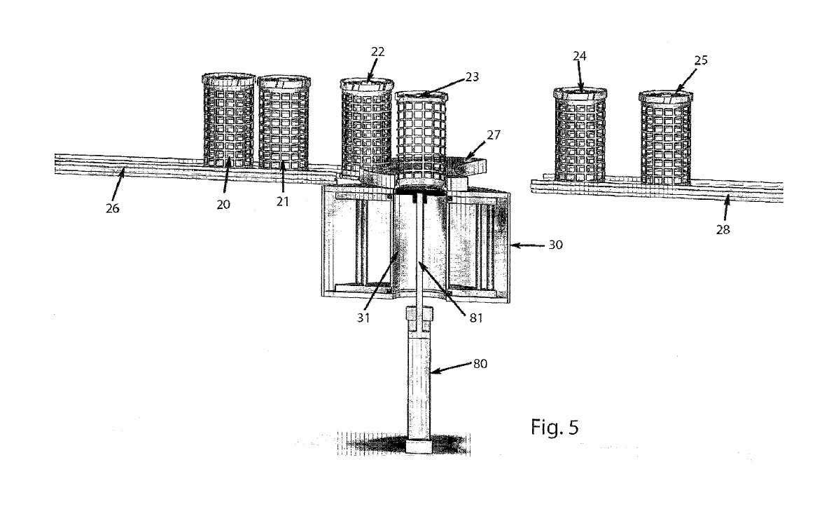

FIG. 5 illustrates the means used for loading a basket into and unloading a basket from a chamber 31 of the machine 30. The identical elements (baskets, loading or unloading drip tray) corresponding to FIGS. 2 to 4 are identified by the same reference numerals. The loading/unloading means for example comprise a cylinder 80 and a piston 81 which are able, on the one hand, to push the treated basket 23 (or the next baskets) out of the chamber 31 (this is the situation illustrated in FIG. 5) and then bring the new basket that is to be treated (in this case the basket 22) into the chamber 31 when the loading/unloading means 27 has moved them into their new position (as in FIG. 4).

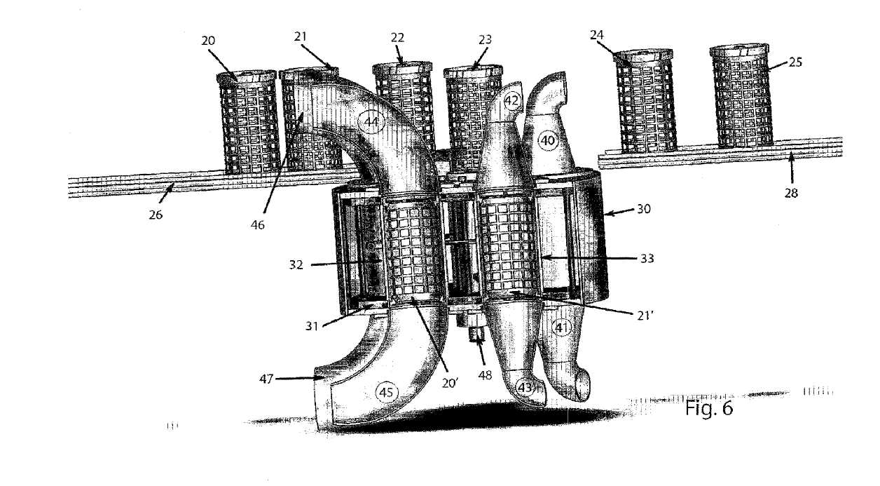

FIG. 6 is a perspective and part-sectioned view of the machine. The components and elements that are identical to those already described are identified by the same numerical references. In this figure, apart from said elements already described (drip trays or rails 26, 28, baskets 20-25, machine 30) the carousel comprising the chambers 32, 33 (seen in section) containing baskets 20′, 21′ has been illustrated in greater detail. As will have been understood from the present description, the machine 30 comprises several stations, five stations in the embodiment illustrated, one being a basket loading/unloading station, which are evenly distributed in a circle which means that the rotating of the carousel 31 allows each chamber (notably the chambers 32, 33) thereof to move on to each of the stations provided.

The successive stations are illustrated by the entries/exits 40/41 for the first station, 42/43 for the second station, 44/45 for the third station and 46/47 for the fourth station. Typically, these stations may correspond to those described with reference to FIG. 1. In alternative variants, different stations may of course be provided (for example having different functions).

In this illustrative example, there are four stations and therefore five chambers in the carousel 31, one station being provided for supplying the carousel with baskets and unloading these therefrom. It is of course possible to provide other numbers of stations (higher or lower numbers) than the number illustrated in this nonlimiting example.

As described previously, the carousel 31 rotates about an axis 48 (for example mounted on ball bearings), driven by appropriate means (for example a motor or a system of gears or some other equivalent means) which have not been depicted, and causes each chamber to pass from one station to another successively so that the station can carry out the intended operation on the baskets brought in succession through the rotating of the carousel 31.

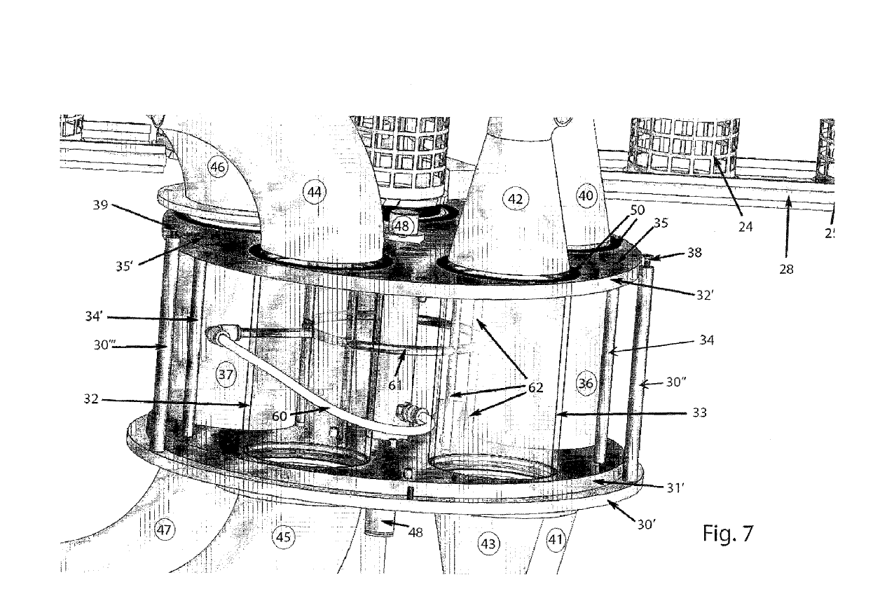

The carousel 31 and the chambers are depicted in greater detail in FIG. 7, in which the elements that are identical to those described previously are identified with the same numerical references. More specifically, the carousel 31 is formed for example of two disk-shaped plates 31′ and 32′ which are joined together by uprights 34, 34′ distributed about the circumference of the disks. These uprights are, for example, formed of rods with screws 35, 35′ at each end. The carousel 31 also comprises closed chambers 32, 33, 36 and 37 which are intended to contain the baskets.

In this FIG. 7, the machine 30 is depicted partially dismantled in as much that, aside from the fact that the external casing has been removed in the figure, only the bottom wall 30′ and the uprights 30″ and 30′″ have been illustrated. The top wall is not illustrated and is fixed to the bottom wall 30′ by the uprights 30″ and 30′″ and the screws 38, 39. The uprights 30″ and 30′″ are not restricted to two in number and are distributed about the circumference of the bottom wall 30′ and the top wall.

In order to seal the chambers closed when the treatment of the station is performed, each chamber of the carousel 31 comprises, at each end, an active seal that will be described in greater detail later on. In FIG. 7, these seals are referenced 50. To operate these seals, use is made for example of a compressed-air system with the air arriving along the axis 48 of the carousel 31. A pneumatic circuit comprising a supply 60 which is connected to a distributor 61 is connected into the carousel. The distributor comprises a ring-shaped part and lateral branches 62 which open into the plates 31′, 32′ at the seals in order to operate these and seal the chambers closed when treatment is being carried out.

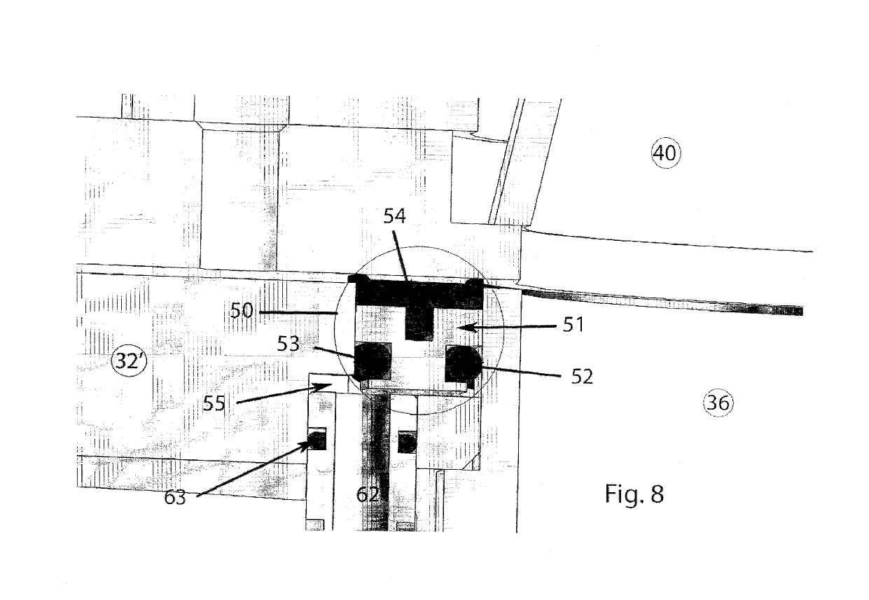

FIG. 8 illustrates in detail the connection of a branch 62 of the distributor in the plate 32′ of the carousel, sealing being afforded by a seal 63 of the O-ring type. This cross-sectional detail is, for example, taken through the chamber 36 when it is at the first station 40. The seal 50 comprises a cut washer 51 (for example made of metal) with two internal seals 52, 53 and one external seal 54. The internal seals 52, 53 seal the chamber 55 which will be filled with air under pressure. This pressure will cause the seal to move (upwards in FIG. 8) and this will compress the seal 54 against the upper part which is the top wall of the machine 30 thus hermetically sealing the chamber 36 because the seal 50 extends all around the chamber 36 and because there is another identical seal on the other side of the chamber (toward the bottom in the figure, but not depicted, activated in the same way).

Thus, through suitable pneumatic control, by increasing the pressure it is possible to seal all the chambers hermetically using the active seal when the parts are to be treated and then, by releasing the pressure a little, the carousel can be turned by one step while still maintaining a certain level of sealing.

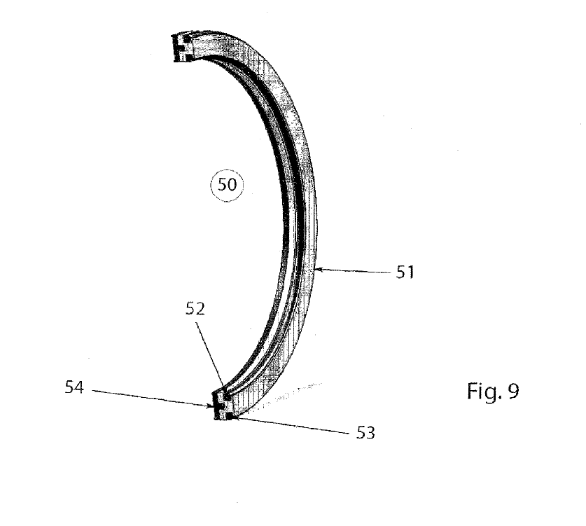

FIG. 9 illustrates half a seal 50 in section and in perspective. As indicated, each end of the chamber has such a seal which allows each chamber to be sealed closed during treatment and prevent liquid, for example, used for the treatment, being released into the atmosphere.

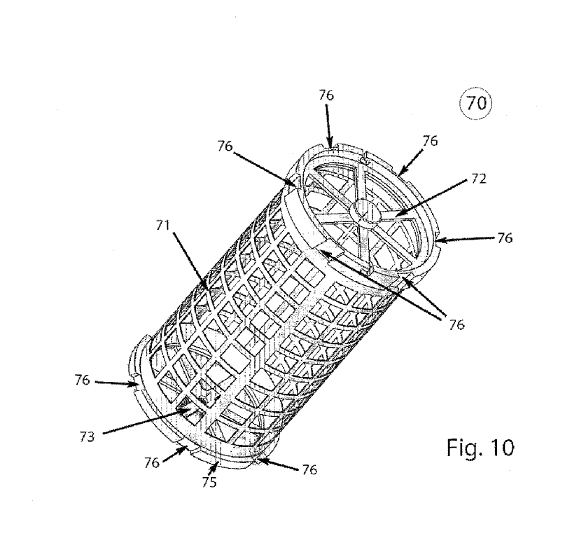

FIG. 10 schematically illustrates a basket as used in the present invention. This basket 70 is identical to the baskets 20-25 described in the preceding figures and the present description applies to these also. The basket 70 therefore preferably is of cylindrical shape and comprises an external wall 71 which includes openings to allow the treatment liquids to pass. For preference, this basket is made of stainless steel or some other equivalent material. At each end, the basket is closed by walls 72, 73, likewise comprising openings for the same reasons. Such a basket is designed to contain, and suited to containing, the parts that are to be treated, for example that are to be cleaned, and the size of the openings must of course be suited to the size of the objects contained so that they remain inside the basket 70. At each end of the basket 70 there is a circular flange 74, 75 which comprises laterally directed grooves 76. These grooves allow the basket 70 to be turned in its chamber during treatment, for example when a liquid is injected through the chamber. This rotation improves the cleaning of the parts by agitating them in the basket 70 during the course of the treatment.

For preference, the machine 30 is kept at a reduced pressure so as to avoid the possibility of any treatment liquid leaking out of the machine 30.

In the method according to the invention, it is necessary first of all to load the carousel which is assumed empty to start with. Thus, a first basket is loaded into the first chamber, then the carousel is turned through one step (so that the first chamber arrives at the first treatment station and an empty chamber arrives at the loading/unloading station). A second basket is then loaded into the second chamber and the carousel is turned by one step so that the second basket and the second chamber now arrive at the first treatment station while the first chamber and the first basket have moved on to the second treatment station.

The same approach is used to load the third chamber which has arrived at the loading/unloading station, with a third basket and the carousel is rotated by one step. In this way, all the chambers and the baskets move on to the next station and so on as long as there are still empty chambers arriving at the loading/unloading station. As soon as the carousel has been filled, which means that the last empty chamber has received a basket, the next rotation brings on to the loading station the first basket that had been loaded into the first chamber at the outset. This basket has now completed a full treatment cycle and can be removed. As described above, this unloading is performed by a cylindrical piston which pushes the treatment basket out of the chamber and by a transfer means (27, see FIGS. 2 and 3) which means moves the treated basket and brings in a new basket to be treated. The cycle then continues with the carousel rotating by one step, which allows each chamber to move on to the new station and baskets to be exchanged at the loading/unloading station.

This then is a system for the parallel treatment of each basket in each successive station which means that significant time can be saved.

Of course, during loading (starting from a completely empty carousel) as long as the chambers are empty, treatment is preferably not performed in these chambers because there is no need for it. Likewise, if the carousel is to be completely emptied, there is likewise no need to operate the stations the chambers of which are empty with no basket in them.

### Production Rate:

Basket dimensions: diameter 80 mm×length 150 mm.

Working volume of baskets: 0.51×8 (mean density of steel)=4 kg/basket.

Each function is performed in 2 minutes, which is long enough given the small volume of the chambers, giving a rate of cleaned parts of 120 kg/hour.

### Consumptions:

Total electrical power: approx 5.6 kW
Cooling water: 501./hour
kWh/kg ratio=0.033

### Key Advantages:

4× more economical (solvent, electricity, cooling water)
Machine space requirement approx 2 m³ (currently 8 m³).
Low cost of construction, transport, materials.
The option to double the throughput, for example, all that is required is the construction of a carousel size that takes basket of diameter 90 mm×length 200 mm. This will increase the space occupied by the carousel to a diameter of just 350 mm (as opposed to 300 mm for 80 mm baskets).
The system is fully automated, so the operator does not have to be present at the end of the cycle to reload the machine and restart a program.
It can easily be made in stainless steel for the medical sector.

### Preferred Machine Dimensions:

| | |
|---|---|
| Width | 1400 mm |
| Depth | 1000 mm |
| Height | 1200 mm |

### Tank Volumes:

| | |
|---|---|
| Prewash tank | 301 |
| Wash tank | 201 |

### Distiller:

| | |
|---|---|
| Volume | 301 |

### Preferred Powers:

| | | |
|---|---|---|
| Drum motor | 0.10 | kW |
| Solvent pump | 0.20 | kW |
| Refrigerating compressor | 0.80 | kW |
| Distillation element | 3 | kW |
| Fan | 0.50 | kW |
| Vacuum pump | 1 | kW |

### Basket Dimensions

| | | |
|---|---|---|
| Diameter | 80 | mm |
| Depth | 150 | mm |
| Volume | 0.77 | l |
| Working volume | 0.50 | l |
| Max load | 4 | kg |

### Productivity and Cycle Time

4 kg/2 minutes
120 kg per hour
kWh/kg ratio = 0.033

### Other Advantages:

Reduced cost of manufacture (no drying tunnel, door, flap)
Simple to build and to maintain
Transportable for demonstration purposes
Rapid installation
Very little mass to be heated or cooled
Electrical energy saving
Solvent saving
Flexibility of washing, baskets commensurate with the quantities to be cleaned
Less handling on loading
No waiting time lost for restarting and selecting the program
Continuous and automatic operation
Possibility of adding an “express” basket without shutting down the machine
Flexibility to adapt to productivity rates
Each basket (identified) can have its own specific program
The injection of air or solvent may or may not be combined with the rotating of the baskets and the high speed of the flow (solvent)
No mechanized basket conveyor
Simplicity for the manufacturer to switch to a different size

All the embodiments indicated above are given by way of nonlimiting examples and variations remain possible within the context of the present invention, notably through the use of equivalent means.

The machine according to the invention can be used in all types of industry and for treating all types of products.

As indicated, the number of chambers in the carousel and the number of stations can be varied by comparison with the examples indicated in the present application.

1. A machine for treating parts, for example for cleaning metal parts using solvents, which parts are carried in a basket through a treatment station, said machine comprising several treatment stations and a carousel comprising a number of chambers at least equal to the number of stations, said chambers being intended to accept at least one basket carrying said parts, the carousel comprising sealing means and carrying the baskets into the chambers in the successive treatment stations of the machine.

2. The machine as claimed in claim 1, in which one of the stations is a station for loading a basket into/unloading a basket from a chamber.

3. The machine as claimed in claim 1, in which the carousel carries the baskets into the chambers by rotating from one station to another.

4. The machine as claimed in claim 1, in which the sealing means comprise two active seals per chamber.

5. The machine as claimed in claim 1, in which the active seal is operated using pressurized air.

6. The machine as claimed in claim 1, in which the active seal comprises at least one washer, two seals of the O-ring type, and a scraper ring.

7. The machine as claimed in claim 1, comprising means of loading the baskets into/unloading the baskets from the chambers.

8. The machine as claimed in claim 1, in which the loading means comprise at least one cylinder and one piston to pull a basket into a chamber and respectively to push a basket out of a chamber.

9. The machine as claimed in claim 1, comprising at least five stations with a carousel comprising an equal number of chambers.

10. The machine as claimed in claim 1, in which at least one station is a prewash station, one station is a washing station, one station is a drying station and one station is a deodorizing station.

11. A basket for carrying parts that are to be treated for a machine as claimed in claim 1, said basket being cylindrical in shape.

12. The basket as claimed in claim 11, said basket comprising at least one circular flange with laterally directed grooves, said grooves allowing the basket to be rotated in its chamber during treatment in said machine.

13. A method of treating baskets carrying parts in a machine having treatment stations, in which method said baskets pass successively to the various treatment stations and all the baskets of the machine undergo in parallel the treatment corresponding to its respective station.
